(19) United States
(12) Patent Application Publication
(10) Pub. No.: US 2026/0146569 A1
(43) Pub. Date: May 28, 2026

(54) Regulating Module for Regulating an Internal Combustion Engine Supply Air Flowrate

(71) Applicant: Schaeffler Technologies AG & Co. KG, Herzogenaurach (DE)

(72) Inventors: Mounir ALAYA, TOULOUSE (FR); Matthieu JOLY, RABASTENS (FR); Kévin DULAC, Saint Elix d'Astarac (FR)

(73) Assignee: Schaeffler Technologies AG & Co. KG, Herzogenaurach (DE)

(21) Appl. No.: 19/398,669

(22) Filed: Nov. 24, 2025

(30) Foreign Application Priority Data
Nov. 25, 2024 (FR) FR2412888

(51) Int. Cl. F02D 41/00; F02D 9/10

(52) U.S. Cl. CPC F02D 41/0002; F02D 9/1005; F02D 9/105; F02D 2200/0404

(57) ABSTRACT

A module for regulating the flowrate of air supplied to an internal combustion engine is provided. The module includes a throttle valve equipped with a throttle-valve disk, mounted with the ability to rotate in a duct passing through the throttle valve and an electric motor configured to pivot the throttle-valve disk in the duct. The module being further includes a first sensor of linear displacement of a throttle cable connected to a gas handgrip of the vehicle, and a mobile element including a metallic target. The mobile element is configured to move linearly past the first sensor. The mobile element being able to have one end of the throttle cable firmly attached to it. Additionally, the module includes a microcontroller configured to control the electric motor as a function of a measurement of the displacement of the throttle cable which measurement is determined by the first sensor.

### CROSS-REFERENCE TO RELATED APPLICATION

This application claims the benefit of prior foreign application number FR2412888 filed in France on Nov. 25, 2024. The disclosure of the above application is incorporated herein by reference.

### TECHNICAL FIELD

The field of the disclosure is that of controlling a throttle-valve disk that forms part of an internal combustion engine throttle valve. The disclosure applies more particularly, although not exclusively, to combustion-engine vehicles of the two-wheeled or three-wheeled type, but also to low-powered four-wheeled vehicles, for example of the mini buggy, golf buggy or go-kart type. The disclosure also applies to motorized gardening vehicles such as lawnmowers or ride-on mowers and to motorized gardening tools such as leaf blowers or garden shredders.

### BACKGROUND

Historically, as illustrated schematically in FIG. 1, throttle control on a motorcycle has been a mechanical gas control in which the gas handgrip 1 is connected to a first end of a throttle cable 2. The second end of the throttle cable 2 is itself connected to a regulating module 3 that regulates the flowrate of air supplied to an internal combustion engine.

This regulating module 3 that regulates the flowrate of air supplied to an internal combustion engine includes a butterfly-type throttle valve 4. As is known per se, a butterfly-type throttle valve 4 includes a throttling member 5 in the form of a disk, known as the throttle-valve disk, mounted with the ability to rotate in a duct (not illustrated) passing through the throttle valve 4. The throttle-valve disk 5 moves in this duct to regulate the flowrate of a flow of air supplied to the internal combustion engine.

The connection between the second end of the throttle cable 2 and the throttle-valve disk 5 is via a quadrant 6 configured to be made to rotate by the throttle cable 2. Thus, when the gas handgrip 1 is twisted, the cable 2, via the quadrant 6, causes the throttle-valve disk 5 to pivot so that the position adopted by the throttle-valve disk 5 corresponds to that desired by the driver/rider. The module 3 further includes a sensor 7 able to measure the angular position adopted by the throttle-valve disk 5.

This type of module 3 also includes a quadrant return spring 8 returning the quadrant 6 to the rest position when the gas handgrip 1 is released.

The module 3 also includes a microcontroller 9, such a microcontroller 9 is used for managing the actuators and sensors of the internal combustion engine.

While such a solution is economical, it is not, however, able to ensure a precise position for the throttle-valve disk 5. Furthermore, such a solution does not offer the possibility of proposing sophisticated functionalities in the control of the throttle-valve disk 5, such as the functionality for example of regulating the speed.

One known solution, illustrated schematically in FIG. 2, enables such functionalities to be proposed.

With that solution, the position of the gas handgrip 1 is determined directly by a sensor 10 located in the gas handgrip 1. The position of the gas handgrip 1 reflects the desire of the driver/rider to accelerate.

That solution also includes a handgrip return spring 8 returning the gas handgrip 1 to the rest position when the gas handgrip 1 is released.

The position information is then transmitted, via an electric cable 11, from the sensor 10 to a connector 12 of the regulating module 3 that regulates the flowrate of air supplied to an internal combustion engine. Next, the position information is finally transmitted from the connector 12 to the microcontroller 9 of the regulating module 3, which microcontroller 9 notably controls an electric motor 13 configured to position the throttle-valve disk 5 at a determined angle reflecting the desire of the driver/rider to accelerate. This microcontroller 9 may take various pieces of information, for example a set speed preselected by the driver/rider, into consideration when controlling the throttle-valve disk 5. Thus, if the driver/rider selects a set speed and then releases the gas handgrip 1, the microcontroller 9 is able to control the electric motor 13 in such a way as to maintain the position of the throttle-valve disk 5 so as to obtain an air flowrate corresponding to the set speed.

Furthermore, this microcontroller 9 may be used to manage actuators and sensors of the internal combustion engine.

The module 3 further includes a sensor 7 able to measure the angular position adopted by the throttle-valve disk 5.

However, such a sensor 10 located in the gas handgrip 1 is connected to a connector 12 via an electric cable 11. This sensor 10 and this electric cable 11 that includes a plurality of electric wires greatly increase the risk of an electrical fault.

Furthermore, integrating this sensor 10 into the gas handgrip 1 and the electrical connection achieved via the electric cable 11 and the connector 12 entail the use of a special-purpose gas handgrip, namely an electrical handgrip including electric wires dedicated to the sensor 10. Such a technical solution is therefore expensive.

### SUMMARY

One aspect of the disclosure provides a solution for controlling a throttle-valve disk of a butterfly-type throttle valve that an internal combustion engine includes, the solution being inexpensive while at the same time being fairly insensitive to electrical faults.

To this end, the disclosure relates to a module for regulating the flowrate of air supplied to an internal combustion engine. The module includes a throttle valve equipped with a throttle-valve disk, mounted with the ability to rotate in a duct passing through the throttle valve and an electric motor configured to pivot the throttle-valve disk in the duct. The module includes a first sensor of linear displacement of a throttle cable connected to a gas handgrip of the vehicle, and a mobile element having a metallic target. The mobile element is configured to move linearly past the first sensor. The mobile element is able to have one end of the throttle cable firmly attached to it. The module also includes a microcontroller configured to control the electric motor as a function of a measurement of the displacement of the throttle cable which measurement is determined by the first sensor.

Thus, the sensor for measuring the input from the driver/rider is now sited directly in the module rather than in the handgrip. This then makes it possible to maintain a mechanical handgrip and combine with it the module as described, without the need to modify the type of handgrip from the outset. This solution is therefore simple to integrate into a vehicle having a handgrip with cable control.

In addition, the mobile element may be sited at various locations in the module, making the module adaptable to suit the imposed two-wheeled vehicle environment.

As a further preference, the module includes a support that is fixed relative to the throttle valve and positioned facing the first sensor, the mobile element being configured to move linearly on the support.

The support provides the mobile element with mechanical protection and guides the movement of the mobile element.

In some examples, the support includes a guideway projecting out from the support, the throttle cable being configured to be inserted into the guideway so that one end of the throttle cable is attached to the mobile element.

The guideway guides the movement of the throttle cable.

In some implementations, the module includes a control unit in which the microcontroller and the first sensor are mounted, the mobile element has a shape complementary to that of the support, the mobile element being positioned between the support and the control unit.

The control unit mechanically protects the first sensor and the microcontroller.

The cavity formed between the support and the control unit forms a track along which the mobile element can move.

In some implementations, the support has a flat and rectangular shape and extends parallel to the control unit. The mobile element having a shape complementary to that of the support, therefore has the shape of a rectangular parallelepiped.

In some examples, the support includes a first portion extending facing the first sensor, and a second portion extending in the direction perpendicular to the first portion and against the free end of the unit.

The support therefore has an “elbow” shape complementary to the end of the unit. The mobile element extending between the support and the control unit also has an elbow shape.

Thus, the support and the mobile element occupy a small amount of space and volume within the module, because the support and the mobile element espouse the shape of the control unit.

In some examples, the module includes a return spring connected between the guideway and the mobile element. The return spring enables the mobile element and the gas handgrip to return to the rest position corresponding to zero input from the driver/rider.

The module may further include a second sensor of angular position of the throttle-valve disk.

In some implementations, the microcontroller is configured to control the electric motor as a function of a measurement of displacement of the throttle cable, which measurement is determined by the first sensor, and as a function of at least one other parameter.

The at least one other parameter may be a measurement of angular position of the throttle-valve disk which measurement is determined by the second sensor.

In some implementations, the microcontroller is configured to implement at least one vehicle-control mode from among the following vehicle-control modes: a speed regulating mode, a sport mode, a poor-weather/rain mode, an energy-saving mode, a “comfort” driving/riding mode, and according to the vehicle-control mode selected: modify the input applied by the driver/rider at the handgrip and demand that this modified input be applied to the throttle-valve disk.

Another aspect of the disclosure provides a vehicle equipped with an internal combustion engine. The vehicle being notable in that it further includes a regulating module that regulates the flowrate of air supplied to said internal combustion engine as outlined, and a throttle cable secured, at a first end, to a gas handgrip of the vehicle and, at a second end, to the regulating module that regulates the flowrate of air supplied to the internal combustion engine.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 schematically illustrates a functional diagram of a first exemplary regulating module that regulates the flowrate of air supplied to an internal combustion engine according to the prior art.

FIG. 2 schematically illustrates a functional diagram of a second exemplary regulating module that regulates the flowrate of air supplied to an internal combustion engine according to the prior art.

FIG. 3 schematically illustrates a functional diagram of a first exemplary vehicle equipped with a regulating module that regulates the flowrate of air supplied to an internal combustion engine having a linear sensor.

FIG. 4 illustrates the view from above of a first exemplary regulating module that regulates the flowrate of air supplied to a combustion engine.

FIG. 5 illustrates the face-on view of the first exemplary regulating module that regulates the flowrate of air supplied to a combustion engine of FIG. 4.

FIG. 6 illustrates the view from above of a second exemplary regulating module that regulates the flowrate of air supplied to a combustion engine.

FIG. 7 illustrates the view in cross section, on a transverse plane, of the second exemplary regulating module that regulates the flowrate of air supplied to an internal combustion engine of FIG. 6.

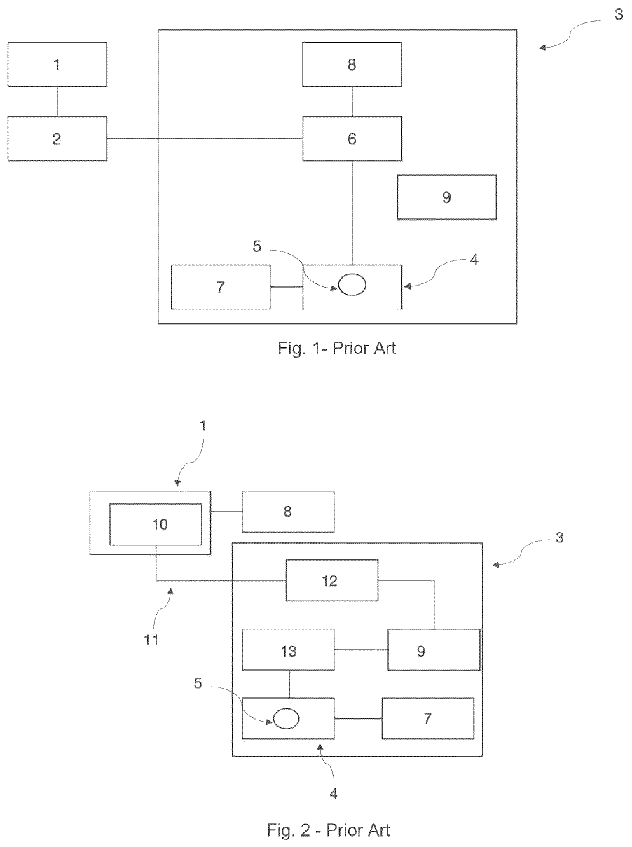

Like reference symbols in the various drawings indicate like elements.

### DETAILED DESCRIPTION

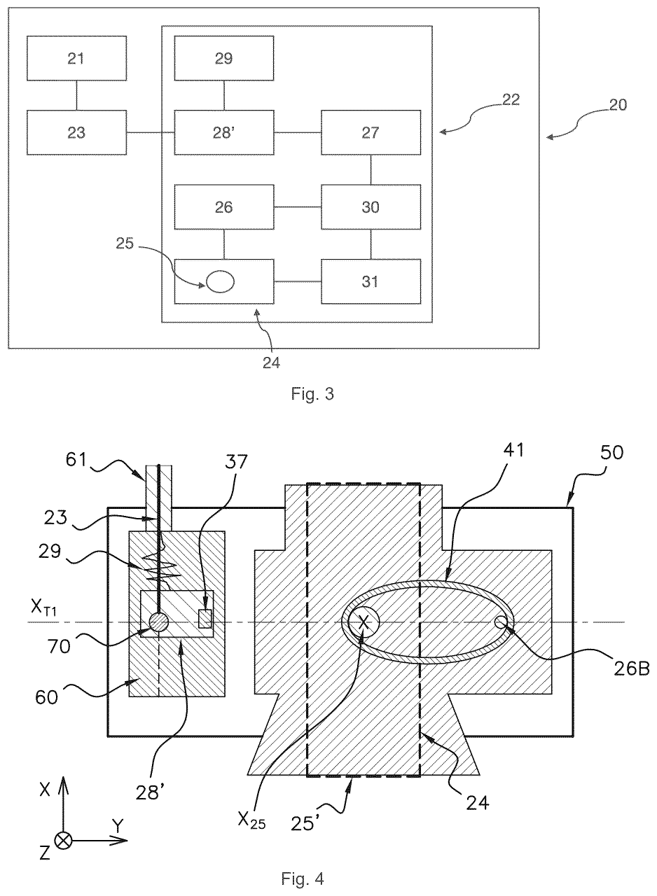

FIG. 3 schematically illustrates a nonlimiting exemplary vehicle 20, for example of two-wheeled type, equipped with an internal combustion engine.

The vehicle 20 includes a gas handgrip 21 and a regulating module 22 that regulates the flowrate of air supplied to the internal combustion engine.

The vehicle 20 further includes a throttle cable 23 secured, at a first end, to the gas handgrip 21 and, at a second end, to the regulating module 22 that regulates the flowrate of air supplied to the internal combustion engine.

The regulating module 22 that regulates the flowrate of air supplied to the internal combustion engine includes a butterfly-type throttle valve 24 equipped with a throttle-valve disk 25. The throttle-valve disk 25 is mounted with the ability to rotate in a duct (25′) passing through the throttle valve 24. The throttle-valve disk 25 moves in this duct to regulate the flowrate of a flow of air supplied to the internal combustion engine.

The regulating module 22 that regulates the flowrate of air supplied to the internal combustion engine further includes an electric motor 26 configured to pivot the throttle-valve disk 25 in the duct 25′and position it at a determined angle.

The regulating module 22 that regulates the flowrate of air supplied to the internal combustion engine includes a first sensor 27 of displacement of the throttle cable 23.

In some examples, illustrated in FIG. 3, the regulating module 22 that regulates the flowrate of air supplied to the internal combustion engine includes a mobile element 28′to which one end of the throttle cable 23 is attached. According to this example, the first sensor 27 is a sensor of linear displacement of the throttle cable 23, for example a magnetic type of sensor. This first sensor 27 is configured to measure a linear displacement of the mobile element 28′.

A return spring 29 is also associated with this mobile element 28′. This return spring 29 enables this mobile element 28′ to be returned to its rest position when the gas handgrip 21 is released by the driver/rider.

Furthermore, the regulating module 22 that regulates the flowrate of air supplied to the internal combustion engine includes a microcontroller 30 configured, amongst other things, to control the electric motor 26 as a function of a measurement of the displacement of the throttle cable 23, this measurement being determined by the first sensor 27.

As shown in FIG. 3, the first sensor 27 measures a linear displacement of the mobile element 28′ and from this deduces the displacement of the throttle cable 23. This measurement of the displacement of the throttle cable 23 is then transmitted to the microcontroller 30 which will control the electric motor 26 in such a way as to pivot the throttle-valve disk 25 in the duct of the throttle valve 24 and thus regulate the flowrate of air supplied to the internal combustion engine.

In some implementation, the regulating module 22 that regulates the flowrate of air supplied to the internal combustion engine includes a second sensor 31 for measuring an angular position of the throttle-valve disk 25. This second sensor 31 is, for example a TPS sensor (“Throttle Position Sensor”).

In that case, the microcontroller 30 is configured to control the electric motor 26 as a function of a measurement of the displacement of the throttle cable 23, which measurement is determined by the first sensor 27 and as a function of at least one other parameter, this other parameter potentially being formed by a measurement of the angular position of the throttle-valve disk 25, which measurement is determined by the second sensor 31.

In other words, thanks to the second sensor 31, the microcontroller 30 is able to determine whether the angular position adopted by the throttle-valve disk 25 corresponds to that desired by the driver/rider, the position desired by the driver/rider being determined via the first sensor 27. Incorrect positioning of the throttle-valve disk 25 may, for example, be brought about by friction of the rotation arm that rotates the throttle-valve disk 25.

If the angular position of the throttle-valve disk 25, as measured by the second sensor 31, does not correspond to that desired by the driver/rider, the microcontroller 30 is able to control the electric motor 26 so as to move the throttle-valve disk 25 and bring it into the desired angular position.

In some examples, the other parameter taken into consideration by the microcontroller 30 for controlling the electric motor 26 may be formed by a predetermined fixed speed value.

For example, the driver/rider of the vehicle 20 may, via a button present on their handlebar, preselect a fixed speed value. This speed value is transmitted to the microcontroller 30. The microcontroller 30 therefore controls the electric motor 26 to move the throttle-valve disk 25 and bring it into the desired angular position corresponding to this fixed speed value. According to such operation, even if the driver/rider releases the gas handgrip 21, the speed of the vehicle 20 will correspond to that preselected.

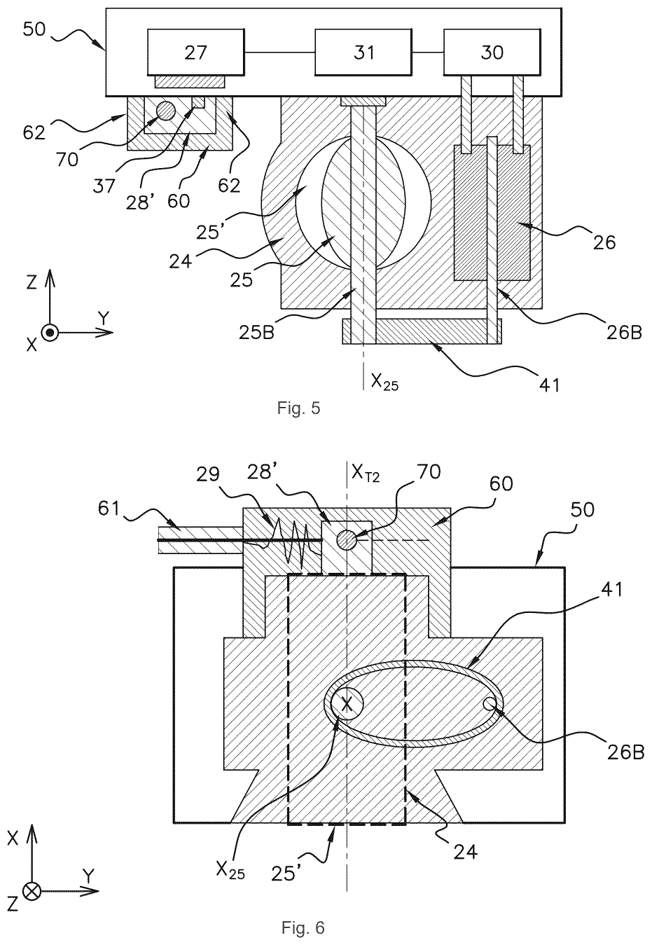

More specifically, a first possible form of the regulating module 22 is described with reference to FIGS. 4 to 5.

More specifically, FIG. 4 depicts the module 22 in an orthonormal frame of reference X, Y, Z. FIG. 5 depicts a cross section through the module 22 depicted in FIG. 4, the cross section being in a YZ plane taken along the axis XT1 depicted in FIG. 4.

According to this example, the rotation arm 25B that rotates the throttle-valve disk 25 and the rotation arm 26B of the electric motor 26 are parallel. However, that does not have to be the case.

The module 22 includes a control unit 50 having an electric circuit extending in a plane parallel to the direction of the duct 25′ and in a plane perpendicular to the axis of rotation X25 of the throttle-valve disk 25. The first sensor 27, the second sensor 31 and the microcontroller 30 are mounted on the electronic circuit (PCB). More specifically, in this case, the first sensor 27 is a coil (constituting an inductive sensor) printed on the electronic circuit.

The control unit 50 is fixed relative to the throttle valve 24. The microcontroller 30 is for example placed facing the electric motor 26 configured to cause the throttle-valve disk 25 to pivot in the duct 25′. The second sensor 31 is configured to be positioned facing one end of the rotation arm that rotates the throttle-valve disk 25.

Furthermore, the module 22 also includes a support 60 having a flat and rectangular shape, extending parallel to the control unit 50 (and to the electric circuit) and facing the first sensor 27. To save space, the orientation of the support 60 may be contrived to be such that the two long edges of the support 60 extend parallel to the direction in which the duct 25′ extends.

The support 60 also includes a guideway 61 (or in other words a sheath) projecting out from the support 60 in the plane of the support 60 and in the direction of the long edges of the support 60. In other words, the guideway 61 extends parallel to the direction of the duct 25′. The support 60 also includes sidewalls 62 projecting along its longitudinal edges.

The mobile element 28′ has the form of a rectangular parallelepiped of which the shape complements that of the support 60, and which is positioned between the support 60 and the control unit 50, resting against the support 60 and facing the first sensor 27 or, in other words, the coil. The mobile element 28′ is configured to move in linear translation on the support 60. Because the linear translation of the mobile element 28′ is guided by the sidewalls 62, this linear translation is in the direction of the axis of the guideway 61 and therefore in a direction parallel to the direction of the duct 25′.

One end of the throttle cable 23 is inserted into the guideway 61 and connected to the mobile element 28′ by a hook 70. The return spring 29 provides the connection between the guideway 61 and the mobile element 28′.

The mobile element 28′ includes a metallic element referred to as a metallic target 37. Thus, when the user pulls on the handgrip, the throttle cable 23 causes the mobile element 28′ to move in linear translation on the support 60, and the metallic target 37 therefore also moves past the first sensor 27 which will detect and quantify the linear translation of the mobile element 28′.

Specifically, the coil 27 is an inductive sensor capable of measuring the displacement of the metallic target 37 without errors caused by electromagnetic disturbances of the system. The inductive sensor may also be referred to as pedal value sensor (PVS).

The information read by the first sensor 27 is then collected by the microcontroller 30 which will command the electric motor 26 and this will actuate the rotation of the arm 26B of the electric motor 26. A mechanical link 41 connects the arm 26B of the electric motor 26 to the rotation arm 25B that rotates the throttle-valve disk 25. This mechanical link 41 therefore allows the throttle-valve disk 25 to be moved about its axis of rotation X25 in the air intake.

The support 60 thus enables the fixing of the sheath 61 of the throttle cable 23 and provides guidance for the displacement of the mobile element 28′, by virtue of the sidewalls, of the return spring 29 and of the hook 70.

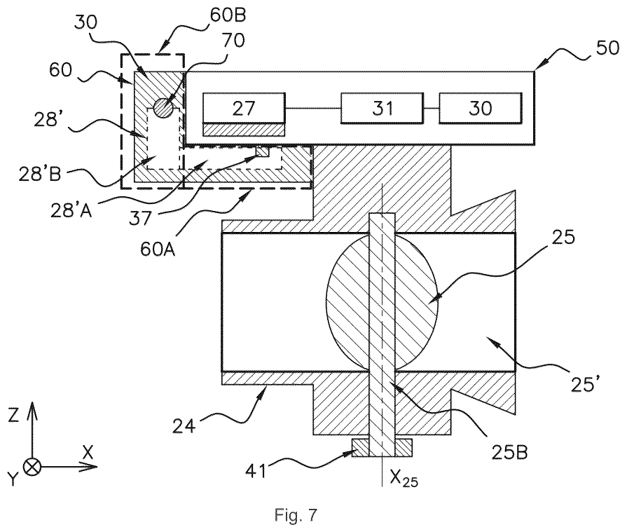

Another aspect of the disclosure is described in FIGS. 6 and 7.

More specifically, FIG. 6 depicts the module 22 in an orthonormal frame of reference X, Y, Z. FIG. 7 depicts a cross section through the module 22 depicted in FIG. 5, the cross section being in an XZ plane taken along the axis XT2 depicted in FIG. 6.

According to this example: the control unit 50 has the shape of a rectangular parallelepiped, the first sensor 27 is positioned at one end of the control unit 50, and the support 60 has an “elbow” shape complementary to the end of the control unit 50. The support 60 includes a first portion 60A which extends facing the first sensor 27 (in the same way as in the first example), and a second portion 60B extending in the direction perpendicular to the first portion 60A, and against the free end of the control unit 50, the free end here corresponding to the same end of the control unit 50 as the end at which the first sensor 27 is mounted.

The mobile element 28′ extends between the support 60 and the control unit 50 and has a shape complementary to that of the support 60. The mobile element 28′ therefore also has an elbow shape and includes a first portion 28′A configured to be positioned between the first portion 60A of the support 60 and the control unit 50. The first portion includes the metallic element 37. In addition, the mobile element 28′ includes a second portion 28′B configured to be positioned between the second portion 60B of the support 60 and the control unit 50. The second portion includes the hook 70 to which the throttle cable 23 is attached.

The guideway 61 is positioned projecting from the second portion 60B of the support 60, in a direction perpendicular to that of the axis along which the duct 25′ extends.

According to this example, the linear translation of the mobile element 28′ with respect to the support 60 and to the first sensor 27 is in a direction perpendicular to that of the axis along which the duct 25′ extends.

However, the assembly including the control unit 50, the support 60 and the mobile element 28′ (regardless as to whether this assembly has a flat shape or elbow shape) may be positioned at any location around the throttle valve 24 provided that the outlet for the cable 23 permits this and provided that the displacement of the target 37 is movement past the first sensor 27.

The various abovementioned aspects of the disclosure have numerous advantages. Among these, mention can be made of: maintaining a mechanical handgrip and a throttle cable while at the same time incorporating the reading of the displacement of the throttle cable directly into the module rather than into the handgrip; the fact that there is no direct mechanical link between the handgrip 21 and the throttle-valve disk 25 enables the module 22 to include additional functionalities such as the following vehicle-control modes: a speed-regulating mode, in which the microcontroller 30 is configured to maintain the speed of the vehicle at a speed that is substantially constant irrespective of commands input by the driver/rider using the handgrip 21, a sport mode in which the microcontroller 30 precisely adheres to the acceleration input at the handgrip 21, the throttle-valve disk 25 therefore exactly mirrors the wishes of the driver/rider, the speed of the vehicle being proportional to the rate at which the handgrip 21 is twisted. That allows highly responsive vehicle behavior consistent with the wishes of the driver/rider, a poor-weather/rain mode: the microcontroller 30 limits acceleration referred to as “sharp”. The torque desired by the driver/rider is achieved, but the acceleration input by the driver/rider may be reduced by the microcontroller 30, thereby avoiding potential overacceleration which could lead to vehicle instability, an energy-saving mode in which the microcontroller 30 limits the extent to which the throttle-valve disk 25 is opened, for fuel-consumption purposes. Thus, even if the driver/rider twists the handgrip 21 to its maximum extent, the extent to which the throttle-valve disk 25 is opened may be restricted to 50% for example, a “comfort” mode in which the microcontroller 30 adapts the input applied by the driver/rider via the handgrip 21 and applies this input to the throttle-valve disk 25 in such a way that the variation in vehicle speed caused by an acceleration input by the driver/rider remains constant and therefore so that the driving/riding experience is more pleasant for the driver/rider. For example, in the event of the handgrip 21 being twisted quickly, the microcontroller 30 is configured to adapt the duration for which the demanded acceleration is applied to the throttle-valve disk 25. In another scenario, if the driver/rider applies mini-twists that are unwanted (and that therefore should not trigger a jump in speed), the microcontroller 30 is configured to smooth/filter these stepwise twists of the handgrip 21. Thus, the input applied by the driver/rider is respected, while at the same time avoiding jerky engine operation. The ability to adapt the siting of the control unit 50, the support 60 and the mobile element 28′ around the throttle-valve disk 25 according to the configuration of the vehicle into which the module 22 is to be integrated, the elimination of the electrical-fault risk associated with the use of a sensor mounted directly on the handgrip.

A number of implementations have been described. Nevertheless, it will be understood that various modifications may be made without departing from the spirit and scope of the disclosure. Accordingly, other implementations are within the scope of the following claims.

1. A module for regulating the flowrate of air supplied to an internal combustion engine, the module comprising:
a throttle valve (24) including a throttle-valve disk, the throttle valve mounted to rotate in a duct passing through the throttle valve;
an electric motor configured to pivot the throttle-valve disk in the duct;
a first sensor of linear displacement of a throttle cable connected to a gas handgrip of the vehicle;
a mobile element comprising a metallic target, the mobile element configured to move linearly past the first sensor, the mobile element attached to one end of the throttle cable;
a microcontroller configured to control the electric motor as a function of a measurement of the displacement of the throttle cable, the measurement is determined by the first sensor;
a support fixed in relation to the throttle valve and positioned facing the first sensor, the mobile element configured to move linearly on the support, the support comprising a guideway projecting out from the support, the throttle cable configured to be inserted into the guideway so that one end of the throttle cable is attached to the mobile element; and
a control unit in which the microcontroller and the first sensor are mounted, the mobile element has a shape complementary to that of the support, the mobile element positioned between the support and the control unit.

2. The module of claim 1, wherein the support has a flat and rectangular shape and extends parallel to the control unit.

3. The module of claim 1, wherein the support comprises:
a first portion extending facing the first sensor; and
a second portion extending in the direction perpendicular to the first portion and against the free end of the control unit.

4. The module of claim 1, further comprising a return spring connected between the guideway and the mobile element.

5. The module of claim 1, further comprising a second sensor of angular position of the throttle-valve disk.

6. The module of claim 5, wherein the microcontroller is configured to control the electric motor as a function of a measurement of displacement of the throttle cable, which measurement is determined by the first sensor, and as a function of at least one other parameter.

7. The module of claim 6, wherein the at least one other parameter is a measurement of angular position of the throttle-valve disk which measurement is determined by the second sensor.

8. The module of claim 1, wherein the microcontroller is configured to:
implement at least one vehicle-control mode from among the following vehicle-control modes:
a speed regulating mode,
a sport mode,
a poor-weather/rain mode,
an energy-saving mode,
a “comfort” driving/riding mode,
and according to the vehicle-control mode selected: modify the input applied by a driver/rider at the handgrip and demand that this modified input be applied to the throttle-valve disk.

9. A vehicle equipped with an internal combustion engine, the vehicle comprising:
a regulating module of claim 1 that regulates the flowrate of air supplied to the internal combustion engine; and
a throttle cable secured, at a first end, to a gas handgrip of the vehicle and, at a second end, to the regulating module that regulates the flowrate of air supplied to the internal combustion engine.
